(19) United States
(12) Patent Application Publication
(10) Pub. No.: US 2023/0364902 A1
(43) Pub. Date: Nov. 16, 2023

(54) LAMINATING APPARATUS, IMAGE FORMING SYSTEM, STORAGE MEDIUM, AND CONTROL DEVICE

(71) Applicant: KONICA MINOLTA, INC., Tokyo (JP)

(72) Inventor: Yuki YAMAUCHI, Tokyo (JP)

(21) Appl. No.: 18/140,572

(22) Filed: Apr. 27, 2023

(30) Foreign Application Priority Data
May 10, 2022 (JP) 2022-077337

(51) Int. Cl. B32B 41/00; B32B 37/18; B32B 37/12; G03G 5/147; B32B 38/00

(52) U.S. Cl. CPC B32B 41/00; B32B 37/182; B32B 37/12; G03G 5/14721; B32B 38/145; B32B 2309/105; B32B 2309/70

(57) ABSTRACT

A laminating apparatus including: a laminating processor that executes laminating processing of laminating a film on a recording medium on which an image is formed; and a hardware processor that acquires information regarding image formation on the recording medium and determines whether to execute the laminating processing by the laminating processor on the recording medium based on the information regarding the image formation.

### REFERENCE TO RELATED APPLICATIONS

The entire disclosure of Japanese Patent Application No. 2022-077337 filed on May 10, 2022, including description, claims, drawings and abstract is incorporated herein by reference in its entirety.

### TECHNICAL FIELD

The present invention relates to a laminating apparatus, an image forming system, a storage medium, and a control device.

### DESCRIPTION OF THE RELATED ART

Japanese Unexamined Patent Publication No. H 05-338039 discloses a printing and processing apparatus in which all processes from printing to a laminating processing are integrated in a manufacturing process for covering a printed matter with a transparent plastic film.

Such a printing and processing apparatus reduces manpower required for each process.

Such a printing and processing apparatus completes all processes from printing to the laminating processing by automatic operation.

### SUMMARY OF THE INVENTION

A case of performing the laminating processing using printed matter and a film that a user handles for the first time and the like will be described. In this case, the printed matter may be a sheet type that is not easily laminated or may be laminated under inappropriate processing conditions. In this case, there is a possibility that the quality of the output material is deteriorated, or the film is not appropriately attached, so that the sheet cannot be passed. In a case where such a state occurs, there is a risk that the laminating apparatus breaks down.

Japanese Unexamined Patent Publication No. H 05-338039 only discloses inhibiting the laminating processing when the temperature of the preheater in the laminator is lower than a target value. The invention described in Japanese Unexamined Patent Publication No. H 05-338039 is insufficient to solve the above problems.

An object of the present invention is to provide a laminating apparatus, an image forming system, a storage medium, and a control device that can more appropriately perform the laminating processing.

To achieve at least one of the abovementioned objects, according to an aspect of the present invention, a laminating apparatus reflecting one aspect of the present invention includes: a laminating processor that executes laminating processing of laminating a film on a recording medium on which an image is formed; and a hardware processor that acquires information regarding image formation on the recording medium and determines whether to execute the laminating processing by the laminating processor on the recording medium based on the information regarding the image formation.

To achieve at least one of the abovementioned objects, according to an aspect of the present invention, an image forming system reflecting another aspect of the present invention includes: an image former that forms an image on a recording medium; a laminating processor that executes laminating processing of laminating a film on the recording medium on which the image is formed by the image former; and a hardware processor that acquires information regarding image formation on the recording medium and determines whether to execute the laminating processing by the laminating processor on the recording medium based on the information regarding the image formation.

To achieve at least one of the abovementioned objects, according to an aspect of the present invention, a storage medium reflecting another aspect of the present invention stores a computer readable program for a computer of a laminating apparatus that includes a laminating processor that executes laminating processing of laminating a film on a recording medium on which an image is formed, the program causing the computer to function as a hardware processor that acquires information regarding image formation on the recording medium and determines whether to execute the laminating processing by the laminating processor on the recording medium based on the information regarding the image formation.

To achieve at least one of the abovementioned objects, according to an aspect of the present invention, a control device reflecting another aspect of the present invention includes a hardware processor that controls a laminating processor that performs laminating processing of laminating a film on a recording medium on which an image is formed, wherein the hardware processor acquires information regarding image formation on the recording medium and determines whether to execute the laminating processing by the laminating processor on the recording medium based on the information regarding the image formation.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a front view illustrating a schematic configuration of the image forming system according to the present embodiment;

FIG. 2 is a functional block diagram showing a control structure of the image forming system according to the present embodiment;

FIG. 3 is a flowchart showing the flow of the processing possibility determination process;

FIG. 4 is a diagram illustrating an example of the first table;

FIG. 5 is a diagram illustrating an example of the second table;

FIG. 6 is a diagram illustrating an example of the third table; and

FIG. 7 is a flowchart showing the flow of the process when setting is not possible.

### DETAILED DESCRIPTION

Embodiments of a laminating apparatus, an image forming system, a storage medium, and a control device of the present invention will be described below with reference to the accompanying drawings.

However, the scope of the invention is not limited to the disclosed embodiments.

<1 Configuration of Image Forming System>

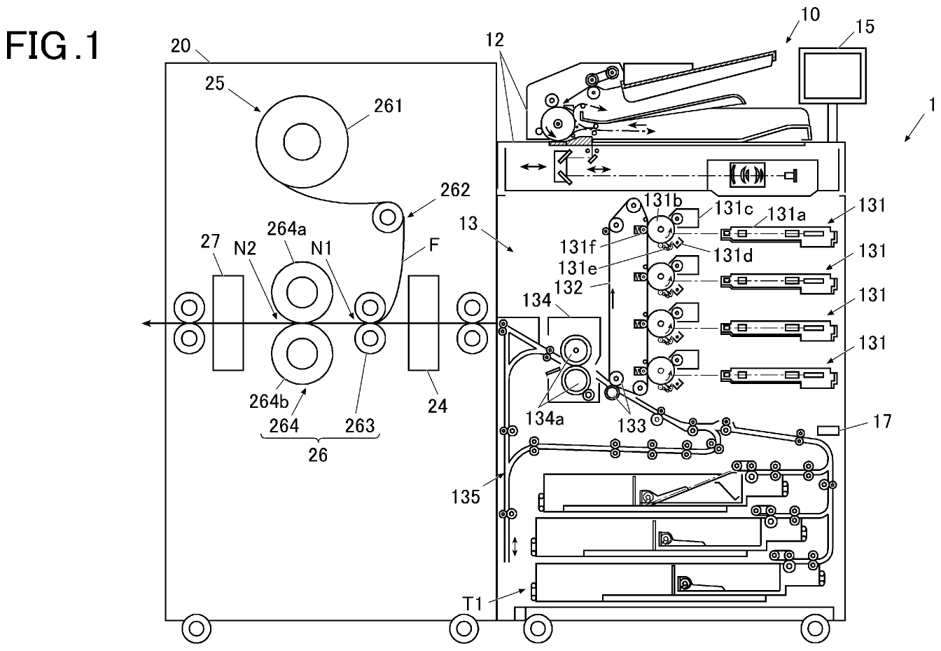

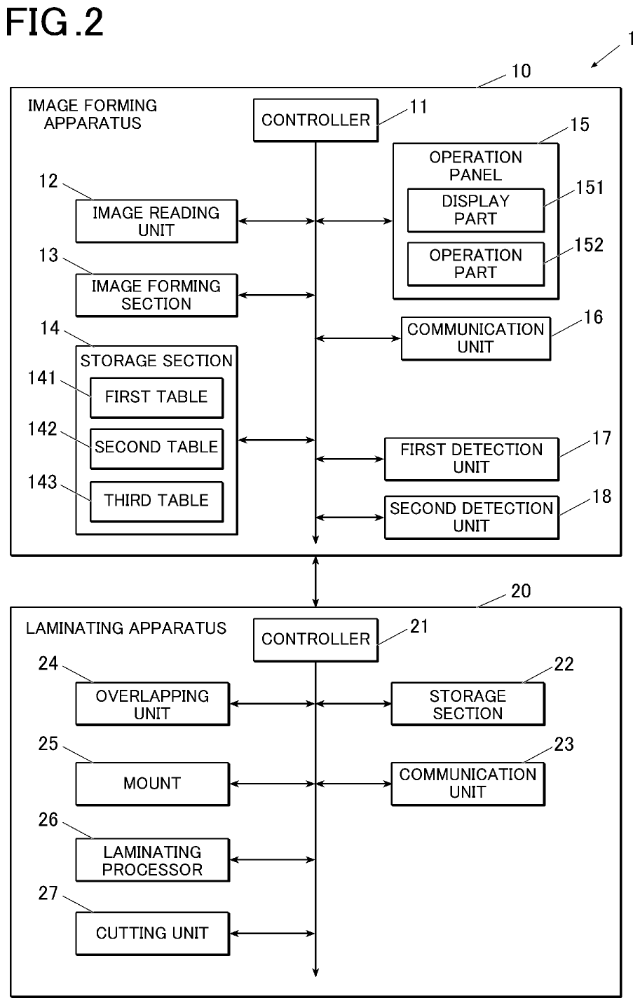

As shown in FIGS. 1 and 2, the image forming system 1 according to the present embodiment includes an image forming apparatus 10 and a laminating apparatus 20.

The laminating apparatus 20 laminates a sheet on which an image has been formed by the image forming apparatus 10. The sheet is a recording medium.

As shown in FIGS. 1 and 2, the image forming apparatus 10 includes a controller 11 (hardware processor), an image reading unit 12, an image forming section 13, a storage section 14, an operation panel 15, a communication unit 16, a first detection unit 17, and a second detection unit 18.

The controller 11 includes a central processing unit (CPU), a random access memory (RAM), a read only memory (ROM), and the like. The CPU reads various processing programs stored in the ROM and develops the programs in the RAM in response to an operation signal input from the operation part 152 or an instruction signal received by the communication unit 16. The CPU integrally controls the operation of the image forming apparatus in cooperation with various programs expanded in the RAM.

The controller 11 acquires information regarding image formation on a sheet. The controller 11 determines whether or not the laminating processor 26 is to laminate the sheet on the basis of the information regarding image formation. The sheet is a recording medium.

The controller 11 selects any one film F from a plurality of types of films F attached to the mount 25 described below. The controller 11 functions as a selection unit.

When the controller 11 determines not to perform the laminating processing, it provides a notification that the laminating processing is not to be performed. The controller 11 functions as a first notification unit.

When the controller 11 determines not to perform the laminating processing, the controller 11 changes the processing conditions for the laminating processing. The controller 11 functions as a changing unit.

The controller 11 notifies the processing condition changed by the changing unit. The controller 11 functions as a second notification unit.

The controller 11 acquires predetermined information related to the change of the processing condition. The controller 11 functions as an acquisition unit. The predetermined information related to a change of processing condition is priority information.

The controller 11 functions as a control device.

The image reading unit 12 scans and exposes an image of a document placed on a document table or an auto document feeder (ADF) (not shown) by an optical system of a scanning exposure device. The image reading unit 12 reads the reflected light in the scanning exposure. The image reading unit 12 reads the reflected light by using a line image sensor to obtain an image signal. The image reading unit 12 performs processing such as analog-to-digital (AID) conversion, shading correction, and compression on the image signal, and then inputs the image signal to the controller 11 as image data. Note that, the image data input to the controller 11 is not limited to the image data read by the image reading unit 12. For example, the image data input to the controller 11 may be included in a print job received from an unillustrated external apparatus via the communication unit 16.

The image forming section 13 forms an image composed of four colors of C, M, Y, and K on a sheet according to the pixel values of four colors of each pixel of the original image subjected to image processing by an electrophotographic method.

As shown in FIG. 1, the image forming section 13 includes four writing sections 131, an intermediate transfer belt 132, a secondary transfer roller 133, and a fixing section 134.

Four writing sections 131 are arranged in series (tandem) along the belt surface of the intermediate transfer belt 132, and form images of the respective colors of C, M, Y, and K.

The writing sections 131 have the same configuration except that they form images in different colors.

Each of the writing sections 131 includes an optical scanning section 131a, a photoreceptor 131b, a developing section 131c, a charging section 131d, a cleaning section 131e, and a primary transfer roller 131f.

In image formation, the charging section 131d charges the photoreceptor 131b in each writing section 131. Thereafter, the optical scanning section 131a emits a light beam based on the original image to scan the photoreceptor 131b, thereby forming electrostatic latent images. The developing section 131c develops by supplying a color material such as toner. An image is thus formed on the photoreceptor 131b.

The primary transfer rollers 131f of the four writing sections 131 sequentially transfer the images formed on the photoreceptors 131b to the intermediate transfer belt 132 so that the images overlap. The transfer is primary transfer. Thus, an image of each color is formed on the intermediate transfer belt 132. The intermediate transfer belt 132 is an image bearing member that is wound around a plurality of rollers to rotate. After the primary transfer, the cleaning section 131e removes the coloring material remaining on the photoreceptor 131b.

The image forming section 13 feeds a sheet from the sheet feed tray T1 in accordance with the timing at which the image on the rotating intermediate transfer belt 132 reaches the position of the secondary transfer roller 133. In the present embodiment, the sheet is a flat sheet. The secondary transfer roller 133 includes a first roller and a second roller that form a pair. The first roller comes into pressing contact with intermediate transfer belt 132. The second roller is one of a plurality of rollers around which the intermediate transfer belt 132 is wound. A secondary transfer roller 133 transfers an image from the intermediate transfer belt 132 onto a sheet by pressing contact. The transfer is secondary transfer. Thereafter, the image forming section 13 conveys the sheet to a fixing section 134 to perform fixing processing, and conveys the sheet to a laminating apparatus 20. The fixing processing is a process of fixing an image on a sheet by heating and pressing the sheet with the fixing roller 134a. In a case in which images are to be formed on both sides of a sheet, the image forming section 13 conveys the sheet to a reverse path 135 to reverse the side of the sheet, and then feeds the sheet again to the position of the secondary transfer roller 133.

The storage section 14 is a nonvolatile storage means constituted by a hard disk drive (HDD), a solid state drive (SSD), or the like. The storage section 14 stores various programs, various setting data, and the like in a readable and writable manner from the controller 11.

The storage section 14 stores the type of sheet (sheet type), thickness (sheet thickness), surface roughness, and the like.

The storage section 14 stores a sheet conveyance speed as a processing speed at which an image is formed and fixed on a sheet in the image forming section 13.

The storage section 14 stores a range of processing conditions that can be set in the laminating processing for each film type. The processing conditions are processing pressure, processing temperature, and processing speed.

The storage section 14 stores priority information. The priority information is information as to whether or not to change the film F to be used for the laminating processing in the process when setting is not possible described later when the laminating apparatus 20 includes a plurality of different types of films F. The priority information is information as to whether or not a specific film F as a predetermined film is used in the laminating processing.

The priority information may be included in a print job received from an external apparatus or may be input by a user via the operation part 152.

The storage section 14 stores a first table 141, a second table 142, and a third table 143.

The first table 141 is a correspondence table between a processing temperature and a processing pressure in the laminating processing. The first table 141 is based on the film thickness of the film F and the basis weight or the sheet thickness of the sheet for each processing speed of the laminating processing. The processing temperature is a temperature of a nip portion N2 heated by the heating roller 264a which will be described later. The processing pressure is a pressure in the nip portion N2 formed by the heating roller 264a and a later-described pressure roller 264b.

The second table 142 is a correspondence table of the correction value of the processing temperature in the laminating processing based on the sheet type of the sheet.

The third table 143 is a correspondence table of a correction value of the processing temperature based on a coverage rate which is a rate of toner placed on a sheet in an image to be formed.

The operation panel 15 includes a display part 151 that displays various kinds of information to a user, and an operation part 152 that receives an operation input from the user.

The display part 151 may be, for example, a color liquid crystal display (LCD). The display part 151 displays an operation screen and the like in accordance with a display control signal input from the controller 11. The operation screen and the like are various setting screens, various buttons, operation states of respective functions, and the like.

The operation part 152 includes a touch panel provided on the screen of the display part 151 and various hard keys arranged around the screen of the display part 151. When a button displayed on the screen is pressed with a finger, a touch pen, or the like, the operation part 152 detects the XY coordinates of the pressed force point as a voltage value. The operation part 152 outputs an operation signal associated with the detected position to the controller 11. Note that the touch panel is not limited to a pressure-sensitive type, and may be, for example, an electrostatic type or an optical type. When a hard key is pressed, the operation part 152 outputs an operation signal associated with the pressed key to the controller 11. A user can operate the operation part 152 to perform settings related to image formation such as image quality setting, magnification setting, application setting, output setting, and sheet setting, a sheet conveyance instruction, a stop operation of the apparatus, and the like.

The communication unit 16 is an interface that connects the image forming apparatus 10 to a communication network. The communication unit 16 includes a communication integrated circuit (IC) and a communication connector. The communication unit 16 transmits and receives various kinds of information to and from an external device connected to a communication network using a predetermined communication protocol under the control of the controller 11. The communication unit 16 can also input and output various kinds of information via a universal serial bus (USB).

The first detection unit 17 detects the type, thickness, and surface roughness of the sheet at a position upstream of the image forming section 13 in the sheet conveyance path, and outputs the detection result to the controller 11. The type of the sheet is a sheet type. The thickness of the sheet is a sheet thickness. The controller 11 stores the received detection result in the storage section 14.

The second detection unit 18 detects temperature and humidity in the image forming system 1 or around the image forming system 1, and outputs the detection result to the controller 11.

The laminating apparatus 20 includes a controller 21 (hardware processor), a storage section 22, a communication unit 23, an overlapping unit 24, a mount 25, a laminating processor 26, and a cutting unit 27.

The controller 21 includes a CPU, a RAM, a ROM, and the like. The CPU reads various processing programs stored in the ROM and develops the programs in the RAM in response to an instruction signal received by the communication unit 23. The CPU integrally controls the operation of the laminating apparatus 20 in cooperation with various programs expanded in the RAM.

The storage section 22 is a non-volatile storage means including an HDD and an SSD.

The storage section 22 stores various programs, various setting data, and the like in a readable and writable manner from the controller 21.

The storage section 22 stores information regarding the type of the film F. The information regarding the type of the film F is film type information. The film type information is, for example, a film thickness.

The communication unit 23 is an interface that connects the laminating apparatus 20 to a communication network. The communication unit 23 includes a communication IC and a communication connector. The communication unit 23 transmits and receives various kinds of information to and from an external apparatus connected to the communication network using a predetermined communication protocol under the control of the controller 21. The communication unit 23 can also input and output various kinds of information via a USB.

As illustrated in FIG. 1, the overlapping unit 24 is disposed upstream from the laminating processor 26 in the sheet conveyance path.

An overlapping unit 24 overlaps the rear end part of a preceding sheet on the upper part of the front end part of a succeeding sheet by a prescribed overlapping amount and conveys the sheet sheets in a continuous belt form.

The mount 25 is configured such that film rolls 261 of a plurality of different types of films F can be mounted, and any of the mounted film rolls 261 can be selected.

The mount 25 may have a configuration in which any one type of film roll 261 is mounted on the mount 25. The mount 25 may have a configuration in which two or more types of film rolls 261 are simultaneously mounted on the mount 25.

The laminating processor 26 executes a laminating processing of continuously attaching the film F to the surface side of the sheet overlapped by the overlapping unit 24 on which the image is formed by the image forming apparatus 10. The surface on which the image is formed is a front surface.

The laminating processor 26 includes a film roll 261, a film transport path 262, a bonding unit 263, a fixing section 264, and the like.

The film roll 261 is a roll of a film F including a transparent resin film layer and an adhesive layer.

The film conveyance path 262 conveys the film F from the film roll 261 to a nip part N1 of the bonding unit 263.

A case in which two or more types of film rolls 261 are simultaneously mounted on the mount 25 will be described. In this case, the film F of the film roll 261 selected by the instruction signal of the controller 11 moves along the film transport path 262 and is transported to the nip portion N1 of the bonding unit 263.

As illustrated in FIG. 1, the bonding unit 263 includes two rollers. The bonding unit 263 sandwiches the sheet and the film F in a nip part N1 formed by the two rollers, so that the adhesive layer of the film F adheres to the front side of the sheet. Thus, the sheet and the film F are bonded together.

The fixing section 264 includes a heating roller 264a and a pressure roller 264b.

The heating roller 264a has a halogen heater or the like built-in and functions as a heater.

The pressure roller 264b is pressed against the heating roller 264a by being urged upward by an unillustrated urging member such as a spring. The heating roller 264a and the pressure roller 264b are in surface contact with each other to form a nip part N2. That is, the heating roller 264a and the pressure roller 264b function as a pressurizer.

The heating roller 264a and the pressure roller 264b fuse the adhesive layer of the film F in the nip part N2, and make the fused adhesive layer adhere to the front face of the sheet, so as to be bonded by heat pressure bonding.

The controller 11 controls the temperature of the heating roller 264a, the pressure of the pressure roller 264b, and the processing speed in the laminating processing by the heating roller 264a and the pressure roller 264b. The temperature of the heating roller 264a is a processing temperature. The pressure of the pressure roller 264b is a processing pressure.

The cutting unit 27 inserts a cutting blade between the sheets overlapped by the overlapping unit 24 to cut only the film F and separate the sheets from each other.

<2 Operation of Image Forming System>

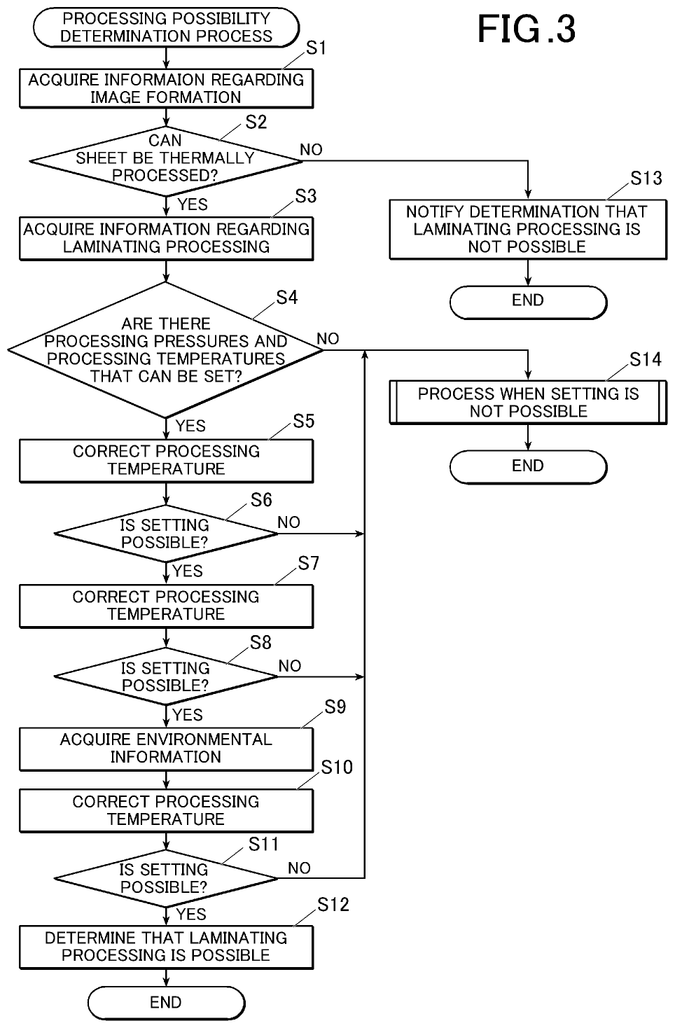

Next, an operation performed by the image forming system 1 in the present embodiment will now be described. FIG. 3 is a flowchart illustrating the procedure of the processing possibility determination process executed by the image forming system 1.

Upon receiving a print job including the laminating processing, the controller 11 of the image forming apparatus 10 executes processing possibility determination process.

The controller 11 executes the processing possibility determination process to determine, based on the information regarding image formation and the information regarding the laminating processing, whether or not to execute the laminating processing

The information regarding image formation includes a sheet type, a sheet thickness, a surface roughness, and a coverage rate of the sheet.

The information regarding the laminating processing includes film type information on the film F and processing speed information on the laminating processing.

(Processing Possibility Determination Process)

In the processing possibility determination process, the controller 11 acquires information regarding the sheet type, sheet thickness, surface roughness, and coverage rate of the sheet, which are information regarding image formation on the sheet (step S1).

In step S1, the controller 11 acquires the sheet type, sheet thickness, and surface roughness of the sheet detected by the first detection unit 17 and stored in the storage section 14.

The controller 11 acquires coverage rate information from the job information of the received job.

Next, the controller 11 determines, based on the sheet type information acquired in step S1, whether or not the sheet is of a sheet type that can be thermally processed (step S2).

When the sheet is of a sheet type for which thermal processing is possible (step S2; YES), the controller 11 acquires film type information on the film F and a processing speed of the laminating processing (step S3). The film type information of the film F and the processing speed of the laminating processing are information regarding the laminating processing.

In step S3, the controller 11 acquires film type information from the storage section 22 of the laminating apparatus 20 via the communication unit 16.

The controller 11 acquires the sheet conveyance speed as the processing speed of the laminating processing from the storage section 14.

Next, the controller 11 makes the following determination based on the sheet thickness information of the sheet acquired in step S1, the film type information acquired in step S3, and the processing speed of the laminating processing. Specifically, the controller 11 determines whether or not there are processing pressures and processing temperatures that can be set in the laminating processing performed by the laminating processor 26 (step S4).

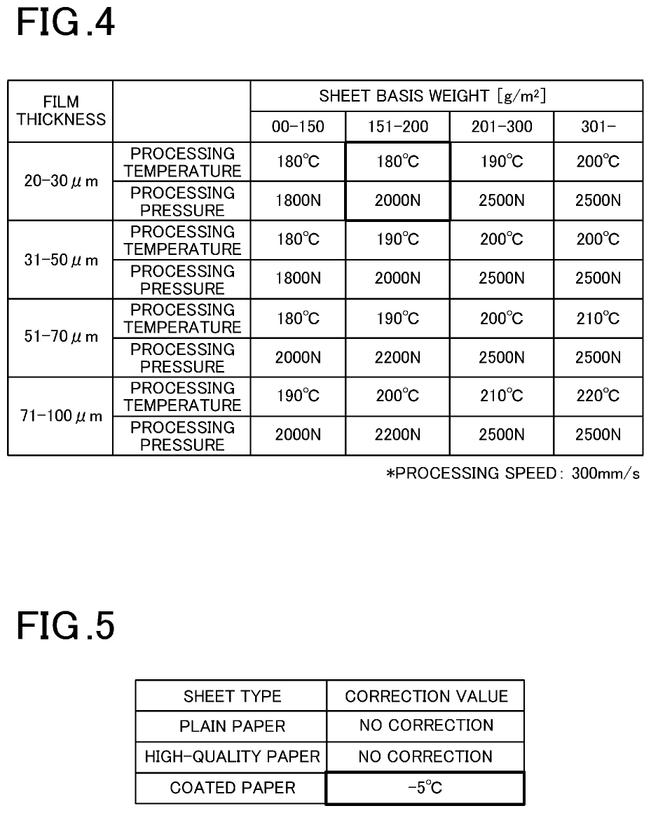

FIG. 4 shows an example of the first table. The example illustrated in FIG. 4 is a correspondence table between processing pressure and processing temperature based on the film thickness of the film F and the basis weight (sheet thickness) of the sheet in a case where the processing speed is 300 mm/s.

In the present embodiment, for example, the film F is a polypropylene film having a film thickness of 30 μm, and the basis weight as the sheet thickness of the sheet is 170 g/m2. In this case, as shown in FIG. 4, the controller 11 determines the processing pressure to be 2000 N and the processing temperature to be 180° C. in step S4, and determines that there are processing pressures and processing temperatures that can be set.

A case where the processing pressure and the processing temperature based on the sheet thickness information of the sheet, the film type information, and the processing speed of the laminating processing do not exist in the first table will be described. In this case, the controller 11 determines that the settable processing pressures and processing temperatures do not exist (step S4; NO).

When there are a processing pressure and a processing temperature that can be set (step S4; YES), the controller 11 corrects the processing temperature determined in step S4 (step S5).

The controller 11 corrects the processing temperature based on the sheet type, sheet thickness, and surface roughness of the sheet acquired in step S1.

FIG. 5 shows an example of the second table.

In the present embodiment, assuming that the sheet is, for example, coated paper, as illustrated in FIG. 5, the correction value of the processing temperature based on the sheet type is −5° C.

In the case of a sheet type in which heat conduction is difficult, the controller 11 sets the correction value so that the processing temperature becomes higher. In the case of a sheet type with rough surface roughness, the controller 11 similarly sets a correction value so that the processing temperature becomes higher. In a case of a sheet type in which curling or wrinkling is likely to occur, the controller 11 sets a correction value such that the processing temperature becomes lower.

Similarly to the correction value based on the sheet type, the controller 11 acquires a correction value based on the sheet thickness and the surface roughness from a table set in advance.

Specific correction values based on the sheet thickness and the surface roughness are omitted.

Next, the controller 11 determines whether or not processing speed, processing pressure, and processing temperature as processing conditions can be set (step S6). The processing speed is the processing speed acquired in step S3. The processing pressure is the processing pressure determined in step S4. The processing temperature is the processing temperature corrected in step S5. The range of the processing conditions that can be set in the laminating processing is stored in the storage section 14 in advance for each film type. The processing condition is the processing pressure, processing temperature and processing speed. For example, the range of the processing temperature that can be set is a range of a temperature at which the adhesive layer of the film F can be fused and the transparent resin film layer is not fused.

When the processing condition can be set (step S6; YES), the controller 11 furthermore corrects the processing temperature corrected in step S5 based on the coverage rate information (step S7).

The coverage rate information is the coverage rate information obtained in step S1.

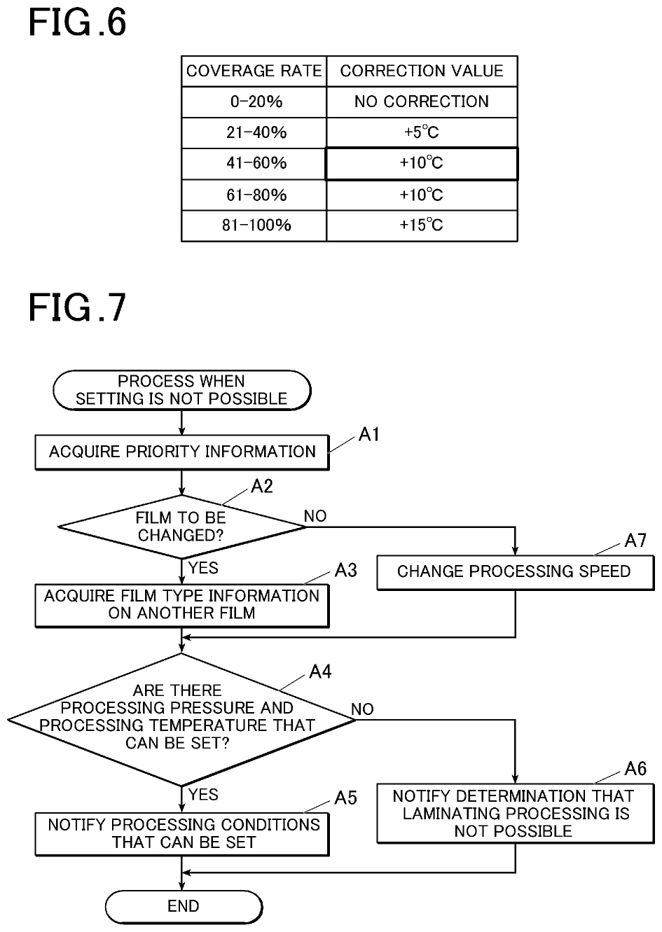

FIG. 6 illustrates an example of the third table.

Assuming that the coverage rate in the print job of the present embodiment is, for example, 50%, as illustrated in FIG. 6, the correction value of the processing temperature based on the coverage rate is +10° C.

The correction value is set such that the processing temperature becomes higher as the coverage rate becomes higher.

Next, the controller 11 determines whether or not processing speed, processing pressure, and processing temperature as processing conditions can be set (step S8). The processing speed is the processing speed acquired in step S3. The processing pressure is the processing pressure determined in step S4. The processing temperature is the processing temperature corrected in step S7.

When the processing condition can be set (step S8; YES), the controller 11 acquires environmental information from the second detection unit 180 (step S9). The environment information includes, for example, temperature and humidity in the image forming system 1 or around the image forming system 1.

Next, the controller 11 furthermore corrects the processing temperature corrected in step S7 (step S10). The controller 11 makes this correction based on the environment information acquired in step S9.

The correction based on the environment information is performed in a case of an environment outside a predetermined range from a standard environment (e.g., a temperature of 20° C. and a humidity of 50%).

Similarly to the correction value based on the sheet type or the coverage rate, the controller 11 may acquire the correction value based on the temperature and the humidity from a preset table or may obtain the correction value by calculation. Specific correction values based on temperature and humidity will be omitted.

Next, the controller 11 determines whether or not processing speed, processing pressure, and processing temperature as processing conditions can be set (step S11). The processing speed is the processing speed acquired in step S3. The processing pressure is the processing pressure determined in step S4. The processing temperature is the processing temperature corrected in step S10.

When the processing conditions can be set (step S11; YES), the controller 11 determines that the laminating processing can be performed. That is, the controller 11 determines to execute the laminating processing (step S12), and the process ends.

In a case where it is determined that the laminating processing is executed in the processing possibility determination process, the controller 11 controls the image forming section 13 to form the job image of the print job on the sheet. Thereafter, the controller 11 controls the laminating apparatus 20 to execute the laminating processing on the sheet on which the image is formed under the processing conditions decided in the processing possibility determination process.

If the sheet is a sheet type that cannot be thermally processed (step S2; NO), for example, the sheet is a sheet type that is discolored or deformed by heat. In this case, the controller 11 determines that the laminating processing is not possible. That is, the controller 11 determines not to perform the laminating processing, and provides a notification by displaying that the laminating processing is not to be performed on the display part 151 (step S13), and ends the present processing.

A case where the settable processing pressures and processing temperatures do not exist (step S4; NO), or a case where the processing conditions are not settable (step S6; NO); (step S8; NO); and (step S11; NO) will be described. This is a case where the controller 11 determines not to execute the laminating processing using the processing conditions decided in the processing possibility determination process. In this case, the controller 11 executes the process when setting is not possible shown in FIG. 7 (step S14), and this processing ends.

(Process when Setting is not Possible)

In the process when setting is not possible, the controller 11 acquires priority information from the storage section 14 (step A1).

Next, the controller 11 determines, based on the priority information acquired in step A1, whether or not to change the film F to be used for the laminating processing to another film F (step A2).

The case where the film F to be used for the laminating processing is changed to another film F (step A2; YES) is a case where the specific film F is not used. In this case, the controller 11 acquires film type information on another film F in the mount 25 (step A3).

Next, the controller 11 determines, based on the sheet thickness information, the film type information, and the processing speed, whether or not there are a processing pressure and a processing temperature that can be set in the laminating processing (step A4). The sheet thickness information is the sheet thickness information of the sheet acquired in step S1. The film type information is film type information of another film F acquired in step A3. The processing speed is the processing speed acquired in step S3. Step A4 is the same as step S4.

A case where settable processing pressures and processing temperatures exist (step A4; YES) will be described. In this case, the controller 11 determines the processing pressure and the processing temperature determined in step A4 and the processing speed acquired in step S3 as settable processing conditions. The controller 11 notifies of the processing conditions by displaying them on the display part 151 (step A5), and the process ends. That is, when the controller 11 determines not to perform the laminating processing using the processing conditions determined in the processing possibility determination process, it changes the processing conditions for the laminating processing. The controller 11 notifies the processing condition changed by the changing unit.

A case where the settable processing pressures and processing temperatures do not exist (step A4; NO) will be described. In this case, the controller 11 executes step A6 and ends the present processing. Step A6 is the same as step S13 of the processing possibility determination process.

The case where the film F used for the laminating processing is not changed to another film F (Step A2; NO) is a case where a specific film F is used. In this case, the controller 11 changes the processing speed of the laminating processing and newly decides the processing speed (step A7). For example, a case where the processing speed, the processing pressure, and the processing temperature are processing conditions under which the film F cannot be sufficiently fixed will be described. The processing speed is the processing speed acquired in step S3. The processing pressure is the processing pressure determined in step S4. The processing temperature is the processing temperature corrected in step S5. In this case, the controller 11 makes the processing speed lower than the processing speed acquired in step S3.

Next, the controller 11 shifts the processing to step A4.

In this case, in step A4, the controller 11 determines, based on the sheet thickness information, the film type information, and the processing speed, whether or not there are a processing pressure and a processing temperature that can be set in the laminating processing. The sheet thickness information is sheet thickness information of the sheet acquired in step S1. The film type information is the film type information of the film F acquired in step S3. The processing speed is the processing speed determined in step A7.

A case where the settable processing pressure and the processing temperature exist (step A4; YES) will be described. In this case, the controller 11 determines the processing pressure and the processing temperature determined in step A4 and the processing speed determined in step A7 as the settable processing conditions. The controller 11 notifies the processing conditions by displaying the processing conditions on the display part 151 (step A5). That is, when the controller 11 determines not to execute the laminating processing using the processing condition determined in the processing possibility determination process, the controller 11 changes the processing condition of the laminating processing. The controller 11 notifies the processing condition changed by the changing unit.

When the controller 11 determines not to perform the laminating processing in the processing possibility determination process or the process when setting is not possible, the controller 11 does not perform the laminating processing on the sheet. The controller 11 may not execute both of the image formation and the laminating processing on the sheet, or may execute the image formation on the sheet and may not execute only the laminating processing.

The laminating method of the above-described embodiment is a hot laminating method of fusing and fixing the adhesive layer of the film F by the fixing section 264, but is not limited thereto. The laminating method may be a cold laminating method in which the fixing section 264 does not perform heating, and the film F including an adhesive layer that can be adhered at room temperature is brought into pressing contact with the sheet by the pressurizer to perform fixing.

In the case of the cold laminating method, the controller 11 corrects the processing pressure based on the coverage rate information or the like in the processing possibility determination process.

Although the film F has a roll shape in the embodiment described above, the film F may be a cut sheet of laminate film.

Although the optional configuration in which the laminating apparatus 20 is attached separately from the image forming apparatus 10 is adopted in the embodiment, there is no limitation thereto. For example, the laminating apparatus 20 may be built in the image forming apparatus 10.

The processing possibility determination process and the process when setting is not possible in the above embodiment are executed by the controller 11, the present disclosure is not limited thereto. The processing possibility determination process and the process when setting is not possible in the above embodiment may be executed by the controller 21 of the laminating apparatus 20. In this case, the controller 21 functions as a control device. A controller of an external device communicably connected to the image forming apparatus 10 or the laminating apparatus 20 may execute the processes. In this case, the controller of the external device functions as the control device.

As described above, the image forming system 1 according to the present embodiment includes the image forming section 13 that forms an image on a recording medium (sheet), the laminating processor 26 that laminates the film F on the recording medium on which an image has been formed by the image forming section 13, and the controller (the controller 11 or the controller 21) that acquires information regarding the image formation on the recording medium and determines whether or not to execute laminating processing by the laminating processor 26 on the recording medium on the basis of the information regarding image formation.

Therefore, it is possible to more appropriately perform the laminating processing by determining that the laminating processing is not to be performed under an inappropriate processing condition.

In the image forming system 1 according to the present embodiment, the information regarding image formation includes information regarding at least one of the type (sheet type), thickness (sheet thickness), surface roughness, and coverage rate of the recording medium.

Accordingly, it is possible to more accurately determine whether or not to laminate the sheet on which the image is formed, based on the type, thickness, surface roughness, and coverage rate of the recording medium.

In the image forming system 1 according to the present embodiment, the controller acquires information regarding the laminating processing and determines whether to perform the laminating processing based on the information regarding the laminating processing.

Therefore, it is possible to more accurately determine whether to perform the laminating processing based on the information regarding the laminating processing.

In the image forming system 1 according to the present embodiment, the information regarding the laminating processing includes information regarding at least one of a type of the film F and a processing speed of the laminating processing.

Therefore, based on the type of the film F and the processing speed of the laminating processing, it is possible to more accurately determine whether or not to execute the laminating processing.

In the image forming system 1 according to the present embodiment, the image formation is image formation by an electrophotographic method.

Therefore, it is possible to more accurately determine whether to perform the laminating processing on a sheet on which an image has been formed by an electrophotographic method.

In the image forming system 1 according to the present embodiment, the laminating processor 26 includes a heater (a heating roller 264a) for fusing the adhesive layer of the film F having a transparent resin film layer and the adhesive layer, and a pressurizer (a heating roller 264a and a pressure roller 264b) that presses (performs pressing contact of) the film F whose adhesive layer has been fused by the heater against the recording medium.

Therefore, it is possible to more appropriately perform the laminating processing in the hot laminating method.

In the image forming system 1 according to the present embodiment, the controller controls at least one of the processing temperature in the heater, the processing pressure in the pressurizer, and the processing speed of the laminating processing.

Therefore, in the hot laminating method, the laminating processing can be performed under appropriate processing conditions.

In the image forming system 1 according to the present embodiment, the laminating processor 26 includes a pressurizer (a heating roller 264a and a pressure roller 264b) that presses (performs pressing contact of) a film F having a transparent resin film layer and an adhesive layer that can be adhered at room temperature, against the recording medium.

Therefore, it is possible to more appropriately perform the laminating processing in the cold laminating method.

In the image forming system 1 according to the present embodiment, the controller controls at least one of the processing pressure in the pressurizer and the processing speed of the laminating processing.

Therefore, in the cold laminating method, the laminating processing can be performed under appropriate processing conditions.

The image forming system 1 according to the present embodiment includes the mount 25 to which a plurality of different types of film F can be attached, and the selection unit (the controller 11 or the controller 21) that selects one of the plurality of types of film F attached to the mount 25, and the laminating processor 26 performs the laminating processing using the film F selected by the selection unit.

Therefore, a film for which appropriate processing conditions can be set is automatically selected, and the laminating processing can be performed using the film.

In the image forming system 1 according to the present embodiment, the film F is a roll-form continuous film or a cut film that has been cut to a predetermined size.

Therefore, the laminating processing can be performed more appropriately regardless of whether a continuous film or a cut film is used.

The image forming system 1 according to the present embodiment includes a first notification unit (the controller 11 or the controller 21) that notifies that the laminating processing is not to be executed when the controller determines not to execute the laminating processing.

Therefore, it is possible to prevent the laminating processing from being performed under inappropriate processing conditions.

The image forming system 1 according to the present embodiment includes a changing unit (the controller 11 or the controller 21) that changes processing conditions for the laminating processing when the controller determines not to perform the laminating processing.

Therefore, the processing conditions of the laminating processing can be changed to be appropriate.

The image forming system 1 according to the present embodiment includes a second notification unit (the controller 11 or the controller 21) that notifies of the processing condition changed by the changing unit.

Therefore, the user can confirm the changed processing conditions.

The image forming system 1 according to the present embodiment includes the acquisition unit (the controller 11 or the controller 21) that acquires predetermined information (priority information) related to a change of processing conditions, and the changing unit changes the processing conditions on the basis of the predetermined information.

Therefore, based on, for example, conditions desired by a user as the priority information, it is possible to change the processing conditions of the laminating processing so as to be appropriate.

In the image forming system 1 according to the present embodiment, the predetermined information is information indicating whether a predetermined film F is to be used in the laminating processing.

Therefore, it is possible to perform the laminating processing using the specific film F.

In the image forming system 1 according to the present embodiment, at least one of the image forming section 13, the laminating processor 26, and the controller (the controller 11 or the controller 21) is independent, and communicably connected to the others.

Therefore, even in an image forming system in which the image forming section 13, the laminating processor 26, and the controller are not integrated, the laminating processing can be more appropriately performed.

In the image forming system 1 according to the present embodiment, when the controller (the controller 11 or the controller 21) determines not to execute the laminating processing, the controller does not cause the image forming section 13 to perform image formation.

Although specific description has been given above on the basis of the embodiment according to the present invention, the present invention is not limited to the above-described embodiment, and modifications can be made without departing from the spirit and scope of the present invention.

For example, in the above-described embodiment, the laminating processing is performed on the surface of the recording medium, but the invention is not limited thereto. The laminating processing may be performed not only on the entire surface of one side of the recording medium but also on a part of the surface, or may be performed not only on one side but also on both sides.

In the above embodiment, the sheet is a cut sheet, but may be a continuous sheet.

Although the image forming section 13 forms an image by an electrophotographic method in the embodiment described above, any image forming method may be used including an inkjet method.

Although it has been described in the aforementioned embodiment that the type (sheet type), the thickness (sheet thickness), and the surface roughness of the sheet are detected by the first detection unit 17 and the controller 11 acquires the detection result, the present invention is not limited thereto.

The controller 11 may acquire the type, thickness, and surface roughness of the sheet set in advance in the print job. The controller 11 may acquire the type, thickness, and surface roughness of the sheet by an input by the user through the operation part 152.

In Step S13 and Step A6 of the embodiment, the controller 11 notifies that the laminating processing is not to be executed by displaying on the display part 151, but is not limited thereto.

In a case where the laminating apparatus 20 includes a display part, the controller 11 may cause the display part of the laminating apparatus 20 to display that the laminating processing is not to be performed. The controller 11 may display, on a display part of an external device communicably connected to the image forming apparatus 10 or the laminating apparatus 20, an indication that the laminating processing is not to be executed.

Similarly, in step A5 of the above-described embodiment, the controller 11 notifies the processing conditions of the laminating processing that can be set by displaying the processing conditions on the display part 151, but the present invention is not limited thereto. The controller 11 may display settable processing conditions on the display part of the laminating apparatus 20. The controller 11 may display settable processing conditions on a display part of an external device communicably connected to the image forming apparatus 10 or the laminating apparatus 20.

The present invention may be applied to a single laminating apparatus 20 that is not connected to the image forming apparatus 10.

In addition, the detailed configuration of each device configuring the image forming apparatus and the detailed operation of each device can also be appropriately changed without departing from the spirit and scope of the present invention.

Although some embodiments of the present invention have been described, the scope of the present invention is not limited to the above-described embodiments, and includes the scope of the invention described in the claims and its equivalent scope. Although embodiments of the present invention have been described and illustrated in detail, the disclosed embodiments are made for purposes of illustration and example only and not limitation. The scope of the present invention should be interpreted by terms of the appended claims.

1. A laminating apparatus comprising:
a laminating processor that executes laminating processing of laminating a film on a recording medium on which an image is formed; and
a hardware processor that acquires information regarding image formation on the recording medium and determines whether to execute the laminating processing by the laminating processor on the recording medium based on the information regarding the image formation.

2. The laminating apparatus according to claim 1, wherein the information regarding the image formation includes information regarding at least one of a type, a thickness, a surface roughness, and a coverage rate of the recording medium.

3. The laminating apparatus according to claim 1, wherein the hardware processor acquires information regarding the laminating processing and determines whether to execute the laminating processing based on the information regarding the laminating processing.

4. The laminating apparatus according to claim 3, wherein the information regarding the laminating processing includes information regarding at least one of a type of the film and a processing speed of the laminating processing.

5. The laminating apparatus according to claim 1, wherein the image formation is image formation using an electrophotographic method.

6. The laminating apparatus according to claim 1, wherein the laminating processor includes:
a heater that fuses an adhesive layer of a film having a transparent resin film layer and the adhesive layer; and
a pressurizer that presses the film, in which the adhesive layer is fused by the heater, against the recording medium.

7. The laminating apparatus according to claim 6, wherein the hardware processor controls at least one of a processing temperature in the heater, a processing pressure in the pressurizer, and a processing speed of the laminating processing.

8. The laminating apparatus according to claim 1, wherein the laminating processor includes a pressurizer that presses a film having a transparent resin film layer and an adhesive layer capable of being adhered at room temperature against the recording medium.

9. The laminating apparatus according to claim 8, wherein the hardware processor controls at least one of a processing pressure in the pressurizer and a processing speed of the laminating processing.

10. The laminating apparatus according to claim 1, further comprising a mount on which a plurality of types of films can be mounted, the plurality of types being different from each other, wherein the hardware processor selects a film from among the plurality of types of the films mounted on the mount, and the laminating processor executes the laminating processing by using the film selected by the hardware processor.

11. The laminating apparatus according to claim 1, wherein the film is a continuous film in a roll form or a cut film cut into a predetermined size.

12. The laminating apparatus according to claim 1, wherein the hardware processor determines not to execute the laminating processing and notifies that the laminating processing is not to be executed.

13. The laminating apparatus according to claim 1, wherein the hardware processor determines not to execute the laminating processing and changes a processing condition of the laminating processing.

14. The laminating apparatus according to claim 13, wherein the hardware processor notifies the changed processing condition.

15. The laminating apparatus according to claim 13, wherein the hardware processor acquires predetermined information related to change of the processing condition and changes the processing condition based on the predetermined information.

16. The laminating apparatus according to claim 15, wherein the predetermined information is information indicating whether to use a predetermined film in the laminating processing.

17. An image forming system comprising:
an image former that forms an image on a recording medium;
a laminating processor that executes laminating processing of laminating a film on the recording medium on which the image is formed by the image former; and
a hardware processor that acquires information regarding image formation on the recording medium and determines whether to execute the laminating processing by the laminating processor on the recording medium based on the information regarding the image formation.

18. The image forming system according to claim 17, wherein at least one of the image former, the laminating processor and the hardware processor is independent, and communicably connected to the other.

19. The image forming system according to claim 17, wherein the hardware processor determines not to execute the laminating processing and does not cause the image former to execute the image formation.

20. A non-transitory storage medium storing a computer readable program for a computer of a laminating apparatus that includes a laminating processor that executes laminating processing of laminating a film on a recording medium on which an image is formed, the program causing the computer to function as
a hardware processor that acquires information regarding image formation on the recording medium and determines whether to execute the laminating processing by the laminating processor on the recording medium based on the information regarding the image formation.

21. A control device comprising a hardware processor that controls a laminating processor that performs laminating processing of laminating a film on a recording medium on which an image is formed, wherein the hardware processor acquires information regarding image formation on the recording medium and determines whether to execute the laminating processing by the laminating processor on the recording medium based on the information regarding the image formation.
